(19) United States
(12) Patent Application Publication
(10) Pub. No.: US 2023/0094390 A1
(43) Pub. Date: Mar. 30, 2023

(54) 3D CONCRETE PRINTING WITH FLEXIBLE TAPE

(71) Applicant: NV Bekaert SA, Zwevegem (BE)

(72) Inventors: Matthias GOUWY, Sint-Jans-Molenbeek (BE); Anne HOEKSTRA, Gerkesklooster (NL)

(73) Assignee: NV Bekaert SA, Zwevegem (BE)

(21) Appl. No.: 17/795,737

(22) PCT Filed: Feb. 16, 2021
(86) PCT No.: PCT/EP2021/053753

§ 371 Date: Jul. 27, 2022

(30) Foreign Application Priority Data
Mar. 4, 2020 (EP) 20160826.2

(51) Int. Cl. B28B 1/00; B33Y 80/00; B28B 23/02; B33Y 10/00; B32B 13/02

(52) U.S. Cl. CPC B28B 1/001; B33Y 80/00; B28B 23/02; B33Y 10/00; B32B 13/02; B32B 2255/02; B32B 2255/26; B32B 2262/103; B32B 2307/732

(57) ABSTRACT

A concrete construction made by 3D concrete printing having two or more layers of cementitious material extruded one above the other, and a reinforcing structure reinforcing the two or more layers. The reinforcing structure has at least two flexible longitudinal elongated steel elements running in lengthwise direction, and one or more flexible transverse steel elements forming an angle with the lengthwise direction so that these flexible transverse steel elements are present in the two or more layers. The structure also has a positioning element for positioning the at least two flexible longitudinal elongated elements and the flexible transverse steel elements, a polymer coating or yarns making stitches. The polymer coating or the stitches are applied on the at least two flexible longitudinal elongated steel elements, on the flexible transverse steel elements and on the positioning element thereby making a bond.

### Technical Field

The invention relates to a concrete construction that has been made by 3D concrete printing.

### Background Art

Additive manufacturing of concrete or cementitious materials, herein referred to as ‘3D concrete printing’, has been expanding rapidly over the past years. According to the technique of 3D concrete printing, a pump feeds a cementitious slurry via a hose to a printing nozzle that extrudes the slurry layer by layer. A gantry robot guides and moves the whole, i.e. the hose and the printing nozzle.

Structures of a cementitious matrix in general, and concrete structures in particular, are known to be brittle and to have a poor resistance to tensile or bending stresses. Adding reinforcement to these structures has given these structures more ductility.

The brittle nature is also a problem for structures made by 3D concrete printing.

Traditional reinforcement such as a rebar can be inserted in the printed layers of concrete while the concrete is still uncured. This solution, however, has serious drawbacks. It is labour intensive, error-prone and the adhesion between the rebar and the concrete will be inadequate. In addition, this solution is against the final goal of 3D concrete printing, namely to minimize manual work.

The Technical University of Eindhoven in cooperation with Bekaert has come up with an elegant solution that allows depositing simultaneously both the concrete and the reinforcement. A reinforcement entraining device having a spool with a flexible steel cord was added to the printer head. This entraining device travels together with the gantry robot, unwinds the flexible steel cord from the spool and introduces this flexible steel cord inside the deposited concrete layer. In this way simultaneous deposition of both concrete and reinforcement was obtained.

While this reinforcement technique adds continuous reinforcement during the 3D printing of concrete it still has the drawback that the reinforcement is limited to reinforcement inside the layers. In other terms, the reinforcement is horizontal, not vertical. The reinforcement does not bridge several layers.

The paper “Mesh reinforcing method for 3D Concrete Printing” by Taylor Marchment and Jay Sanjayan, Automation in Construction, 109 (2020) 102992, discloses a welded mesh that has a height larger than the thickness of a first layer deposited by 3D concrete printing. This welded protrudes out of the first concrete layer and reinforces not only the first concrete layer but also a second concrete layer that is extruded afterwards.

This welded mesh, however, is limited in flexibility and strength. In addition, the welds constitute weak points in the reinforcement.

### DISCLOSURE OF INVENTION

It is a general object of the present invention to mitigate the drawbacks of the prior art.

It is a particular object of the present invention to provide an improved reinforcement that is not limited to the 3D printed concrete layers.

It is another object of the present invention to provide a reinforcement that is flexible, strong and without weak points.

According to the invention, there is provided a concrete construction made by 3D concrete printing. The construction comprises two or more layers of a cementitious material extruded one above the other and a reinforcing structure reinforcing said two or more layers. The reinforcing structure has a length and a height. The reinforcing structure comprises at least two flexible longitudinal elongated steel elements running in lengthwise direction. The reinforcing structure further comprises one or more flexible transverse steel elements forming an angle with the lengthwise direction so that these flexible transverse steel elements are present in the two or more layers. The structure further comprises a positioning element for positioning the at least two flexible longitudinal elongated steel elements and the flexible transverse steel elements. The structure also comprises a polymer coating or yarns making stitches. The polymer coating or the stitches, or both the polymer coating and the stitches, are applied on the at least two flexible longitudinal elongated steel elements, on the flexible transverse steel elements and on the positioning element thereby making a bond between the at least two flexible longitudinal elongated steel elements, the flexible transverse steel elements and the positioning element.

The flexible longitudinal elongated steel elements and the flexible transverse steel elements need to be flexible as must be able to follow the path of a 3D printer head or a 3D extrusion nozzle particularly when the layers of the cementitious matrix make a bend.

The positioning element and the polymer coating or the stitches keep the flexibility.

The flexible longitudinal elongated steel elements provide reinforcement inside the layer, while the flexible transverse steel elements provide reinforcement across the layers, in a transverse direction, thereby bridging two layers.

This flexibility is mainly achieved by using relatively thin steel elements. More particularly, the at least two flexible longitudinal elongated steel elements are preferably steel cords with a cord diameter of maximum 2.0 mm, e.g. maximum 1.50 mm. The steel cords comprise steel filaments twisted together. The maximum filament diameter of the steel filaments is 0.60 mm, e.g. 0.45 mm, e.g. 0.40 mm.

In a first embodiment of the invention, the one or more flexible transverse steel elements may be constituted by one or more steel cords running over the length of the reinforcement structure in a zigzag or sinusoidal way thereby repeatedly going from a first layer to a second layer and back from the second layer to the first layer. Here again, the maximum cord diameter is 2.0 mm, the maximum filament diameter is 0.60 mm.

In a second embodiment of the invention, the one or more flexible transverse steel elements are constituted by discrete reinforcing elements that are spread over the length of the reinforcing structure. The discrete reinforcing elements may be pieces of wire or pieces of steel cord.

In case of pieces of wire the flexibility requires that the diameter is limited to 1.50 mm, e.g. to maximum 1.20 mm. The pieces of wire are preferably provided with anchorages.

These anchorages are in the form of thickened ends, bent parts, flattenings or undulations.

The positioning element may be an open substrate that function as carrier or a glass roving. This positioning element does not necessarily contribute to the reinforcement of the construction.

According to another aspect of the invention, there is provided a process of manufacturing a concrete construction as described above by way of 3D printing. The reinforcing structure is fed simultaneously together with the cementitious material through a same printer head or nozzle.

### BRIEF DESCRIPTION OF FIGURES IN THE DRAWINGS

FIG. 1a and FIG. 1b schematically show how a construction is made by 3D concrete printing;

FIG. 2 shows two layers of a construction reinforced by a first embodiment of a flexible tape;

FIG. 3 shows two layers of a construction reinforced by a second embodiment of a flexible tape.

### MODE(S) FOR CARRYING OUT THE INVENTION

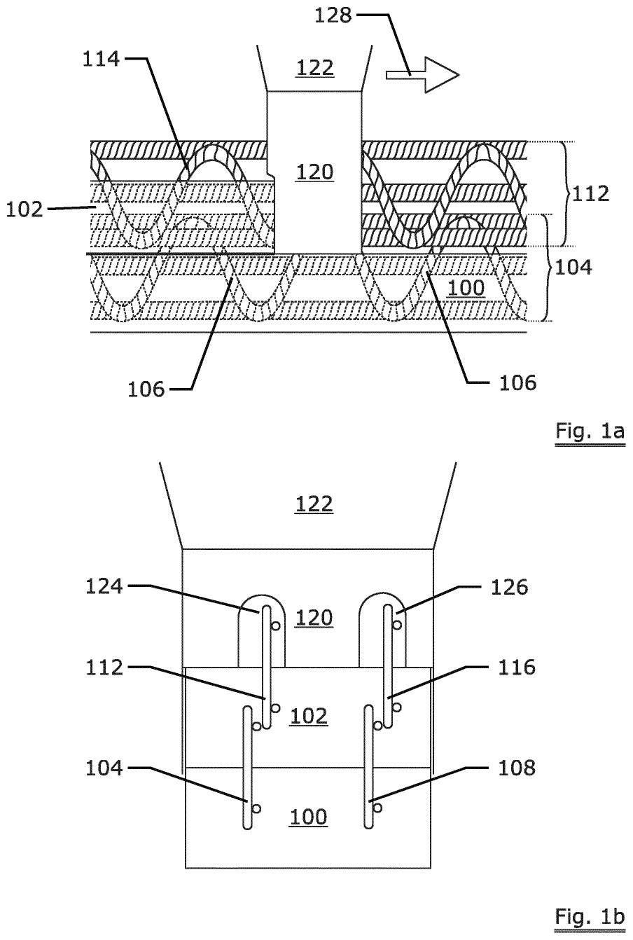

FIG. 1a gives a side view and FIG. 1b gives a transversal view of a way to manufacture a construction made by 3D concrete printing. FIGS. 1a and 1b illustrate this manufacture after one layer 100 has been made and a second layer 102 is being extruded upon the first layer 100.

The first layer 100 already comprises a first flexible tape 104 with steel cords 106 and a second flexible tape 108 with steel cords. These two tapes 104 and 108 are embedded in the first layer 100 and protrude vertically out of the first layer 100. After extrusion of the second layer 102, this second layer 102 covers completely the protruded parts of the tapes 104 and 108. So tapes 104 and 108 will ultimately be embedded in the cementitious matrix of the first layer 100 and the second layer 102. These tapes 104 and 108 provide reinforcement for each of the first layer 100 and second layer 102 separately, taken in isolation. In addition, the tapes 104 and 108 also provide reinforcement for both layers 100, 102 together, since tapes 104 and 108 bridge the interface between the first layer 100 and the second layer 102. The steel cord 106 repeatedly forms a bridge between the first layer 100 and the second layer 102 as steel cord 106 runs in a sinusoidal way from the first layer 100 to the second layer 102 and vice versa.

During extrusion of the second layer 102 above the first layer 100, a third flexible tape 112 with steel cords 114 and a fourth flexible tape 116 with steel cords are added. This third flexible tape 112 and fourth flexible tape 116 are partially embedded in the second layer 102 and protrude out of the second layer 102. The third flexible tape 112 and the fourth flexible tape 116 are intended to reinforce the second layer 102 and the third layer (not shown).

A printer head or nozzle 120 conducts and dimensions a cementitious slurry 122 to form the second layer 102. To allow passage of the protruding parts of the flexible tapes 104, 106, 112 and 116, the printer head 120 is provided with vertical recesses 124 and 126. The printer head 120 is moving in the direction of arrow 128.

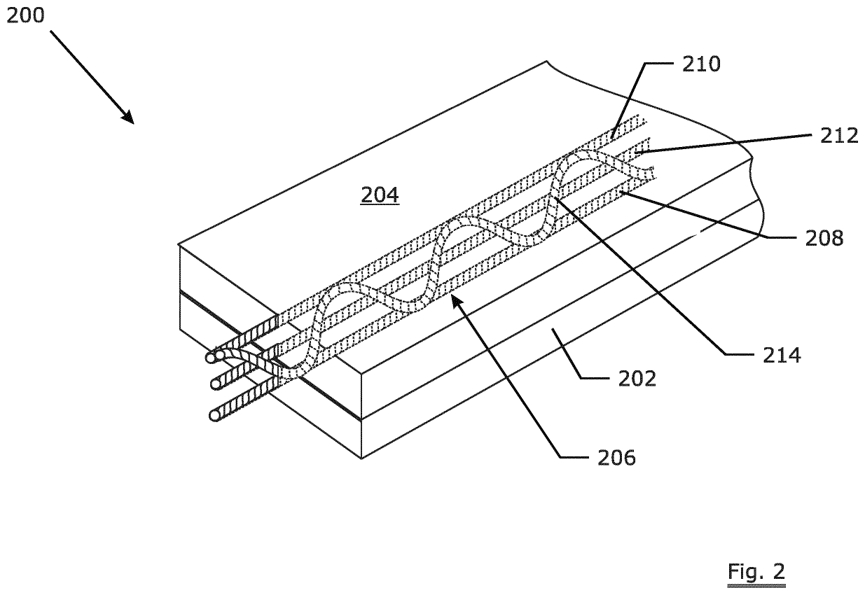

FIG. 2 shows a construction 200 with two layers 202 and 204 both reinforced by a first embodiment of a flexible tape 206. Flexible tape 206 is embedded both in the first layer 202 and in the second layer 204 and provides not only reinforcement for each layer separately but also for both layers taken together since the tape 206 bridges both layers 202 and 204.

Tape 206 has three steel cords running in longitudinal direction: one steel cord 208 forming the bottom edge and being embedded completely in the first layer 202, one steel cord 210 forming the upper edge and being completely embedded in the second layer 204 and one steel cord 212 running in the middle of tape 206. Depending upon its exact position, steel cord 212 may be embedded in the first layer 202 or in the second layer 204. A fourth steel cord 214 runs in a sinusoidal way along the length of the tape 206. This fourth steel cord 214 forms the reinforcing bridge between the first layer 202 and the second layer 204.

The four steel cords 208, 210, 212, and 214 may form a coherent tape. They can be bonded to each other by means of a glue, e.g. a hot melt, or by being stitched to each other or to a substrate.

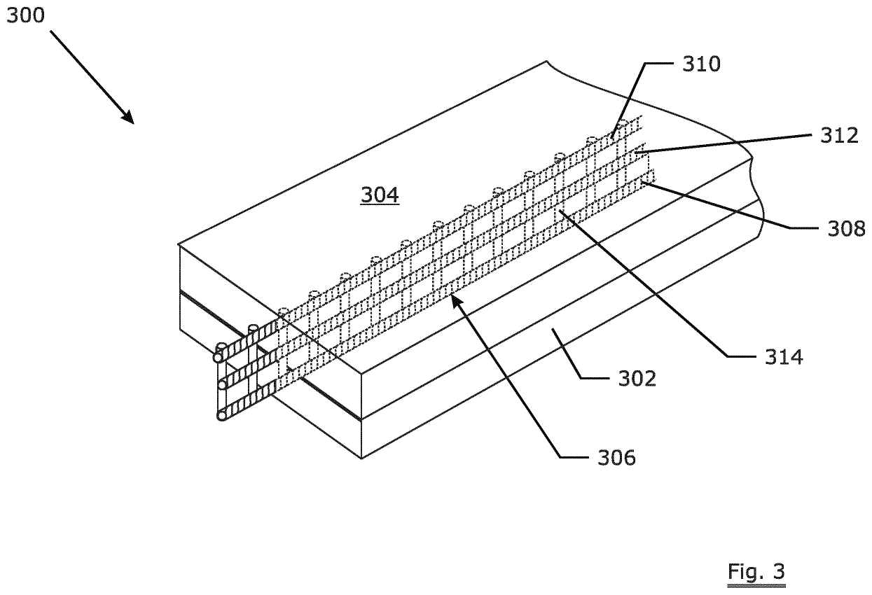

FIG. 3 shows a construction 300 with two layers 302 and 304 both reinforced by a second embodiment of a flexible tape 306. Flexible tape 306 is embedded both in the first layer 302 and in the second layer 304 and provides not only reinforcement for each layer separately but also for both layers taken together since the tape 306 bridges both layers 302 and 304.

Tape 306 also has three steel cords running in longitudinal direction: one steel cord 308 forming the bottom edge and being embedded completely in the first layer 302, one steel cord 310 forming the upper edge and being completely embedded in the second layer 304 and one steel cord 312 running in the middle of tape 306. Depending upon its exact position, steel cord 312 may be embedded in the first layer 302 or in the second layer 304.

The three steel cords 308, 310 and 312 and the separate pieces of wire 314 form the tape. They may be attached to each other by glueing or weaving or they may be stitched to an open substrate (not shown).

From a general point of view, the reinforcing tape comprises at least one reinforcing element that provides a reinforcing effect in transversal direction. This means that this reinforcing element runs—at least partially—in a direction deviating from the longitudinal direction so that is embedded in at least two extruded layers. The most efficient reinforcing effect is obtained by transverse reinforcement elements that form an angle of about 90° with the longitudinal direction, like the pieces of wire 314 in FIG. 3. Reinforcements like the sinusoidal steel cord 214 in FIG. 2 do not have that angle of 90° but have the advantage of a continuous reinforcement. Transverse reinforcement elements that form an angle with the longitudinal direction ranging from 30° to 150° can provide the required reinforcement for two adjacent layers.

Viewed from another general aspect, the flexible reinforcing tape can take various forms.

The reinforcing tape can take the form of a chainlink mesh of limited width or height and consisting of steel cords that have been interwoven with each other.

The reinforcing tape can also take the form of a flexible strip, as disclosed in EP-B1-2 981 659 and in EP-B1-3 201 381, where transverse reinforcing elements have been added.

Steel Composition

The steel cords and the steel wires mentioned hereabove may have a steel composition along following lines:

A plain carbon composition is along following lines (all percentages being percentages by weight):

a carbon content (% C) ranging from 0.40% to 1.20%, e.g. 0.80% to 1.1%;

a manganese content (% Mn) ranging from 0.10% to 1.0%, e.g. from 0.20% to 0.80%;

a silicon content (% Si) ranging from 0.10% to 1.50%, e.g. from 0.15% to 0.70%;

a sulphur content (% S) below 0.03%, e.g. below 0.01%;

a phosporus content (% P) below 0.03%, e.g. below 0.01%.

Alternatively, Following elements may be added to the composition:

chromium (% Cr): in amounts ranging from 0.10% to 1.0%, e.g. from 0.10 to 0.50%;

nickel (% Ni): in amounts ranging from 0.05% to 2.0%, e.g. from 0.10% to 0.60%;

cobalt (% Co): in amounts ranging from 0.05% to 3.0%; e.g. from 0.10% to 0.60%;

vanadium (% V): in amounts ranging from 0.05% to 1.0%, e.g. from 0.05% to 0.30%;

molybdenum (% Mo): in amounts ranging from 0.05% to 0.60%, e.g. from 0.10% to 0.30%;

copper (% Cu): in amounts ranging from 0.10% to 0.40%, e.g. from 0.15% to 0.30%;

boron (% B): in amounts ranging from 0.001% to 0.010%, e.g. from 0.002% to 0.006%;

niobium (% Nb): in amounts ranging from 0.001% to 0.50%, e.g. from 0.02% to 0.05%;

titanium (% Ti): in amounts ranging from 0.001% to 0.50%, e.g. from 0.001% to 0.010%;

antimony (% Sb): in amounts ranging from 0.0005% to 0.08%, e.g. from 0.0005% to 0.05%;

calcium (% Ca): in amounts ranging from 0.001% to 0.05%, e.g. from 0.0001% to 0.01%;

tungsten (% W): e.g. in an amount of about 0.20%;

zirconium (% Zr): e.g. in an amount ranging from 0.01% to 0.10%;

aluminum (% Al): preferably in amounts lower than 0.035%, e.g. lower than 0.015%, e.g. lower than 0.005%;

nitrogen (% N): in amounts less than 0.005%;

rare earth metals (% REM): in amounts ranging from 0.010% to 0.050%.

Steel Cord

As mentioned, a general aspect of the invention is that one or more steel cords provide flexibility to the reinforcing tape. In that respect, the steel cords may comprise two to nineteen steel filaments, preferably two to twelve steel filaments. The filament diameter of the steel filaments may range from 0.20 mm to 0.80 mm, e.g. from 0.30 mm to 0.60 mm.

Metallic Coating

The steel filaments of the steel cord and the steel wires may be provided with a metallic coating in order to increase the corrosion resistance.

The metallic coating is preferably a zinc coating or a zinc alloy coating.

A zinc alloy coating may be a zinc aluminum coating that has an aluminum content ranging from 2 percent by weight to 12 percent by weight, e.g. ranging from 3% to 11%.

A preferable composition lies around the eutectoid position: Al about 5 per cent. The zinc alloy coating may further have a wetting agent such as lanthanum or cerium in an amount less than 0.1 percent of the zinc alloy. The remainder of the coating is zinc and unavoidable impurities.

Another preferable composition contains about 10% aluminum. This increased amount of aluminum provides a better corrosion protection then the eutectoid composition with about 5% of aluminum.

Other elements such as silicon (Si) and magnesium (Mg) may be added to the zinc aluminum coating. With a view to optimizing the corrosion resistance, a particular good alloy comprises 2% to 10% aluminum and 0.2% to 3.0% magnesium, the remainder being zinc.

An example is 5% Al, 0.5% Mg and the rest being Zn.

A zinc or zinc alloy coating is preferably applied to the steel wire by means of a hot dip operation. The average thickness of the metal coating is preferably limited to 4 micrometer, e.g. to 3 micrometer.

With a view of inhibiting hydrogen gas evolution during the hardening of concrete reinforced with zinc coated metal elements, the steel cords may be treated with benzimidazole.

Alternatively, the metallic coating may also be a copper alloy coating such as brass. Brass coated steel wires can be drawn easier than zinc alloy coated steel wires. In a cementitious and alkaline environment as concrete, brass may be sufficient to provide the required corrosion resistance.

### REFERENCE NUMBERS

100 first layer
102 second layer
104 first tape
106 steel cord for first tape
108 second tape
112 third tape
114 steel cord for third tape
116 fourth tape
120 printer head
122 cementitious slurry
124 vertical recess
126 vertical recess
128 direction of movement
200 construction
202 first layer
204 second layer
206 first embodiment of tape
208 steel cord forming bottom edge
210 steel cord forming upper edge
212 steel cord running in middle
214 sinusoidal steel cord
300 construction
302 first layer
304 second layer
306 second embodiment of tape
308 steel cord forming bottom edge
310 steel cord forming upper edge
312 steel cord running in middle
314 pieces of wire

1. A concrete construction made by 3D concrete printing said construction comprising:
two or more layers of cementitious material extruded one above the other, and
a reinforcing structure reinforcing said two or more layers,
said reinforcing structure having a length and a height,
said reinforcing structure comprising at least two flexible longitudinal elongated steel elements running in lengthwise direction,
said reinforcing structure further comprising one or more flexible transverse steel elements forming an angle with said lengthwise direction so that these flexible transverse steel elements are present in said two or more layers,
said structure further comprising a positioning element for positioning said at least two flexible longitudinal elongated elements and said flexible transverse steel elements, a polymer coating or yarns making stitches,
said polymer coating or said stitches being applied on said at least two flexible longitudinal elongated steel elements, on said flexible transverse steel elements and on said positioning element thereby making a bond between said at least two flexible longitudinal elongated steel elements, said flexible transverse steel elements and said positioning element.

2. The construction according to claim 1,
wherein said polymer coating and said stitches being applied on said at least two flexible longitudinal elongated steel elements, on said flexible transverse steel elements and on said positioning element thereby making a bond between said at least two flexible longitudinal elongated steel elements, said flexible transverse steel elements and said positioning element.

3. The construction according to claim 1,
wherein said at least two flexible longitudinal elongated steel elements are steel cords with a cord diameter of maximum 2.0 mm and comprising steel filaments with a filament diameter of maximum 0.60 mm.

4. The construction according to claim 1,
wherein said one or more flexible transverse steel elements is a steel cord running over said length in a zigzag or sinusoidal way thereby repeatedly going from a first layer to a second layer and back from the second layer to the first layer.

5. The construction according to claim 1,
wherein said one or more flexible transverse steel elements are discrete reinforcing elements being spread over the length of said reinforcing structure.

6. The construction according to claim 5,
said discrete reinforcing elements being pieces of wire or pieces of steel cord.

7. The construction according to claim 6,
wherein said pieces of wire are provided with anchorages.

8. The construction according to claim 7,
wherein said anchorages are in the form of thickened ends, bent parts, flattenings or undulations.

9. The construction according to claim 1,
wherein said positioning element is an open substrate functioning as carrier or a glass roving.

10. A process of manufacturing a concrete construction according to claim 1 by way of 3D printing, wherein said reinforcing element is fed simultaneously together with the cementitious material through a same printer head or nozzle.

11. The process of manufacturing a concrete construction according to claim 10, wherein said polymer coating and said stitches being applied on said at least two flexible longitudinal elongated steel elements, on said flexible transverse steel elements and on said positioning element thereby making a bond between said at least two flexible longitudinal elongated steel elements, said flexible transverse steel elements and said positioning element.

12. The process of manufacturing a concrete construction according to claim 10, wherein said at least two flexible longitudinal elongated steel elements are steel cords with a cord diameter of maximum 2.0 mm and comprising steel filaments with a filament diameter of maximum 0.60 mm.

13. The process of manufacturing a concrete construction according to claim 10, wherein said one or more flexible transverse steel elements is a steel cord running over said length in a zigzag or sinusoidal way thereby repeatedly going from a first layer to a second layer and back from the second layer to the first layer.

14. The process of manufacturing a concrete construction according to claim 10, wherein said one or more flexible transverse steel elements are discrete reinforcing elements being spread over the length of said reinforcing structure.

15. The process of manufacturing a concrete construction according to claim 14, said discrete reinforcing elements being pieces of wire or pieces of steel cord.

16. The process of manufacturing a concrete construction according to claim 15, wherein said pieces of wire are provided with anchorages.

17. The process of manufacturing a concrete construction according to claim 16, wherein said anchorages are in the form of thickened ends, bent parts, flattenings or undulations.

18. The process of manufacturing a concrete construction according to claim 10, wherein said positioning element is an open substrate functioning as carrier or a glass roving.
